(19) United States
(12) Patent Application Publication
(10) Pub. No.: US 2017/0053288 A1
(43) Pub. Date: Feb. 23, 2017

(54) Cloud Based Customer Relationship Mapping

(71) Applicant: LandNExpand, LLC, San Diego, CA (US)

(72) Inventor: Jackie Annette Golden, San Diego, CA (US)

(21) Appl. No.: 15/240,776

(22) Filed: Aug. 18, 2016

Related U.S. Application Data
(60) Provisional application No. 62/206,738, filed on Aug. 18, 2015.

(51) Int. Cl. G06Q 30/00; H04L 29/06; G06Q 30/02

(52) U.S. Cl. CPC G06Q 30/01; G06Q 30/0202; H04L 63/08

(57) ABSTRACT

Disclosed is a cloud-based system configured to interface with a Customer Relationship Management (CRM) system. The system compliments a mobile and web-based application allowing users to add additional content not supported by a CRM system, such as images, audio files, documents, and other content considered relevant to a client. The System shares content added by one user with other users associated with a client. The System uses the additional content with the content provided by the CRM system to identify new aspects of a client or update existing aspects such as marketing campaigns, sales and customer service. The system &so uses the combined content to generate industry-related predictions to help identify potential business opportunities and employs analytics to predict future customer behavior. The System may then deliver the relevant information generated by the System to the client-associated user(s).

### RELATED APPLICATIONS

This application claims the benefit of priority to the U.S. Provisional Patent Application for “Cloud Based Customer Relationship Mapping,” Ser. No. 62/206,738 filed on Aug. 18, 2015, and currently co-pending.

### FIELD OF THE INVENTION

The present invention pertains generally to a computer and internet productivity application for use in business having a sales and services department. More particularly, the present invention pertains to a cloud based computer system that collects and houses data associated with a business client or customer. The present invention is particularly, but not exclusively, useful as a productivity enhancement tool that makes customer data and metrics available to company personnel in an office environment and on remote devices.

### BACKGROUND OF THE INVENTION

Customer Relationship Management (“CRM”) refers to practices, strategies, and technologies that companies use to analyze and manage customer interactions and data throughout the customer lifecycle with the goal of improving business relationships with customers, assisting in customer retention, and driving sales growth. The use of CRM allows a business to build client relationships, customer loyalty, and brand value through marketing strategies and activities. To support these strategies and activities, many companies offer CRM software platforms and/or service packages to manage the customer relationship process. The core strength of CRM is its ability to glean insight from customer metrics to create enhanced and focused marketing strategies and customer relationships.

CRM systems have been around for as long as people have been buying and selling. The advent of computer systems has greatly enhanced the CRM process since the key to good CRM is storing, analyzing, and uncovering information about customers. The more a company knows about a customer, the better the company can manage the customer relationship and potentially increase future sales. The nature of computer systems allows for large volumes of customer information to be analyzed and made available to salespeople. The information sought by the salesperson may be found using only a few search terms in the CRM program and may include detailed information on customers' personal information, purchase history, buying preferences, business limitations, and ongoing business concerns. CRM software consolidates customer information and documents into a single CRM database so business users can more easily access and manage it. The other main functions of this software include recording various customer interactions such as email, phone calls, and social media, automating various workflow processes such as tasks, calendars and alerts, and giving managers the ability to track performance and productivity based on information logged within the system.

A simple example of CRM is the customer rewards cards offered by many supermarkets. The reward card gives the buyer access to discounts and special deals. When a customer uses their reward card, the retailer is also able to track what the customer buys allowing the retailer to create a detailed customer profile. Using that information, the retailer can offer targeted coupons, discounts, and communications to motivate the customer to purchase more products from the store. In essence, the more a company knows about its customers, the better it can manage the relationship to increase sales, improve customer support, and better maintain, if not improve, the customer relationship.

In use, a company collects information about a customer with which the company trains its salespeople with analysis of the collected information. Access to this information makes it easy for the company to compile reports that help it to design a strategy tailored to each customer. The analysis of collected information to tailor a strategy to maintain and improve the individual customer company relationship is referred to as a “land and expand” strategy. Since salespeople are often the face of the company, customers with technical issues typically contact the salesperson first instead of contacting customer service since customers prefer to reach out to someone they already know instead of a stranger. This may be a burden on the salesperson, but these ongoing interactions very well may result in future sales. When a salesperson assists the customer with overcoming the problem, it is more likely that the customer will contact the salesperson for future purchases. In this situation, it is also more likely that the customer will refer other business associates, and in some cases, even friends and family. CRM systems also allow a salesperson to set reminders for such things as business anniversaries, birthdays, and other special dates associated with the customer. CRM systems may even be programmed to automatically send out actual messages on special dates with a notice delivered to the salesperson that the system sent the message.

With cloud based CRM, data is stored on a remote network that salespeople can access at any time and at any place with an internet connection. Traditionally, data intake practices for CRM systems have been the responsibility of sales and marketing departments as well as contact center agents. Sales and marketing teams procure leads and update the system with information throughout the customer lifecycle while contact centers gather data and revise customer history records through service call and technical support interactions.

The advent of social media and the proliferation of mobile devices have caused CRM providers to upgrade their offerings to include new features that cater to customers who use these technologies. Social CRM refers to businesses engaging customers directly through social media platforms such as Facebook, Twitter, and LinkedIn. Social media presents an open forum for customers to share experiences with a brand, whether they are airing grievances or promoting products.

In recent years, mobile platforms, or portable computing devices such as smartphones and tablets, have greatly increased the ability for professionals to access business data and maintain contact with their companies while away from the office. Mobile CRM applications built for mobile platforms are becoming a necessary tool for sales representatives and marketing professionals who want to access customer information and perform tasks when they are not physically in their offices. Mobile CRM apps take advantage of features that are unique to mobile devices, such as GPS and voice-recognition capabilities, to better serve customers by giving employees access to this information on the go and facilitating the updating of customer information.

Most CRMs provide a solid profile of the customer for salespeople to manage leads and deals. However, these CRMs do not have an easy way to collect the complex business requirements, customer expectations, and results that are required for understanding how successful the account performs and fully implementing a land and expand strategy. Currently, none of the CRMs on the market offer a solution allowing salespeople and other employees and personnel associated with the customer to collect and document customer requirements, expectations, and successes in a detailed manner that is in one place that personnel can reference, add to and report on. Some of the missing functions are the ability to add dictation summaries from a meeting, recorded meetings or conversations, photos, and copies of whiteboard sessions consisting of text, drawings, and graphics.

What is needed in today's CRM market is one place to quickly view customer information, a quick and easy way to get customer information into the CRM system, a map of the customer's business model, a map of where you have implemented within the account, data on how the customer is using the company's product(s), success of the customer in integrating the company's product into their corporate culture, usage and adoption metrics, and referenceable customer successes with the company's product.

What is also needed is a CRM based program that collects and analyzes customer data to predict, or aid in the prediction of, customer behavior thereby allowing a salesperson or sales team to identify possible business opportunities.

What is also needed is a mobile application fully integrated with the CRM system such that mobile application has the ability to synchronize content directly with the CRM system.

In short, it would be useful to provide an improvement to existing computer technology which would facilitate the implementation and use of a land and expand business strategy by providing new ways to store and analyze customer data, facilitating data sharing between sales teams and other business departments, and predicting customer behavior.

### SUMMARY OF THE INVENTION

A preferred embodiment of the present invention is a computer-based application capable of storing and managing client information and using such information to predict customer behavior. The information is then made available to members of a sales team where the team may access the information through a mobile application or a typical computer. When a data entry is made for a particular client or customer, the data is uploaded to a CRM program, where it is then made available to other personnel having access to the CRM program. In some embodiments, one or more identified accounts receive a notification that the client or customer's account has been updated with new information.

In certain embodiments of the present invention, users may access data associated with a client or customer's organizational chart, business model, workflow, product integration, as well as many other characteristics associated with the business.

The present invention provides an intuitive and easy to use platform allowing for the quick and easy sharing of data between system users, thereby maximizing user sales and service as well as increasing sales of both products and services. The present invention also enhances data exchange between salespeople as well as minimizes any issues associated with the loss of customer specific sales knowledge when a salesperson or other employee leaves the company.

The present invention analyzes information input into the system to generate industry-related predictions to help identify potential business opportunities. The present invention also employs analytics to predict future customer behavior based on specific customer history within specific customer industries. Predictive analytics is an area of data mining that deals with extracting information from data and using it to predict trends and behavior patterns The core of predictive analytics relies on capturing relationships between explanatory variables and the predicted variables from past occurrences and exploiting them to predict the unknown outcome.

Analytical Customer Relationship Management is a frequent commercial application of Predictive Analysis, Methods of predictive analysis are applied to customer data to pursue CRM objectives, which involve constructing a holistic view of the customer no matter where their information resides in the company or the department involved. The present invention uses predictive analysis in applications for marketing campaigns, sales, and customer services to name a few. These tools are required in order for a company to posture and focus their efforts effectively across their customer base. They must analyze and understand the products in demand or have the potential for high demand, predict customers' buying habits in order to promote relevant products at multiple touch points, and proactively identify and mitigate issues that have the potential to lose customers or reduce their ability to gain new ones, Analytical Customer Relationship Management can be applied throughout the customer's lifecycle (acquisition, relationship growth, retention, and win-back). Several of the application areas described below (direct marketing, cross-sell, customer retention) are part of Customer Relationship Managements.

The present invention can use predictive analytics to construct a holistic view of a customer regardless where that information resides in the corporate data structure. The results of predictive analytics are used in marketing campaigns, sales, and customer services The outcomes from the predictive analytics allow a company to focus their efforts maintaining an effective customer relationship, identifying potential cross-sell opportunities, customer retention, direct marketing of existing products or combinations of product versions, fraud detection, and risk management.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a diagram view of the land and expand (LAE) mobile application communicating with a CRM database through LAE Application and Web servers;

FIG. 2 is a diagram view of an LAE mobile application communicating with a CRM database located in the Cloud through LAE Application and Web servers; and

FIG. 3 is a diagram showing the basic function of the business logic portion of the LAE system of the present invention.

### DETAILED DESCRIPTION

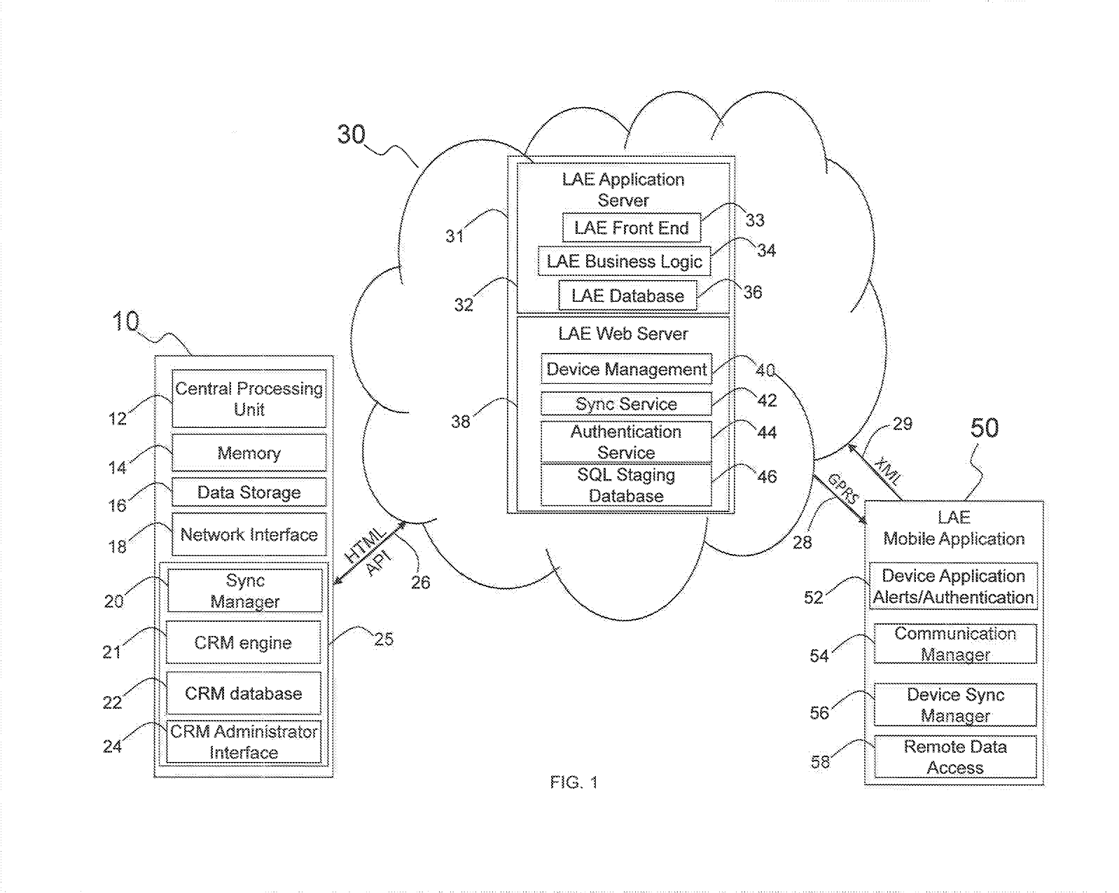

Referring initially to FIG. 1, a diagram view of the LAE mobile application communicating with a CRM database through LAE application and web servers located in the Cloud is shown. CRM database 22 is located on a computing platform 10. Computing platform 10 consists of a central processing unit 12, memory 14 for storing operational instructions and data values, data storage 16, network interface 18, and CRM system 25, comprising sync manager 20, CRM engine 21, CRM database 22, and the CRM administrator interface 24. Computing platform 10 connects to Cloud 30 through network interface 18. Computing platform 10 communicates with the LAE system 31, which consists of the LAE Application Server 32 and the LAE web server 38, by way of data link 26 using HTML (Hypertext Markup Language) and APIs (Application Program Interface). It is to be appreciated by someone skilled in the art that other communication protocols may be implemented without departing from the intent of the present invention.

The CRM database 22 consists of fields, where each field holds a specific piece of information. A group of fields, when taken together, holds all information associated with an account. An account may be for a company or an individual. For example, a field may be for the street address associated with an account, where another field may be for the city associated with the account. The number of fields in CRM database 22 that make up a account profile may remain constant where the number of profiles, and therefore the overall number of fields, increases or decreases in response to the addition or deletion of profiles from the database 22. In certain embodiments, not all profiles contain the exact same fields. The customer account data includes the profile information as well as sales history, pending orders, and closely related information.

Operating in the cloud 30, LAE system 31 reads all fields associated with a customer profile. LAE system 31 can sync voice recordings, videos, and photos collected as an attachment in the LAE application to a CRM system that allow for document attachments. Further, LAE system 31 may also sync field updates associated with a profile. LAE system 31 may also automatically sync accounts, contacts, company, and opportunity information along with any artifacts such as images and documents.

The CRM engine and database 21 and 22 may be any commercially available CRM engine and database, such as Salesforce™. In practice, the LAE application and web servers 32 and 38 are mapped to the CRM database 22 thereby allowing ail data to be shared between the platforms regardless of the CRM program implemented by the user.

Application server 32 consists of the LAE front end 33, the LAE business logic 34, and the LAE database 36. LAE front end 33 contains the user interface that is presented to the user view the website or the mobile application 50. LAE front end 33 presents information to a user in a manner useful to the user. LAE business logic 34 is responsible for providing the different inputs to the front end 33, essentially acting as a broker between front end 33 and the LAE database 36. LAE business logic 34 is responsible for the workflow needed to execute the functionality of the system. For instance, LAE business logic 34 can read a data entry input form from LAE front end 33, apply a business rule or workflow, and then pass the results to the LAE database 36 for final storage. Each component of application server 32 handles specific functions to ensure maximum security of the application server 32.

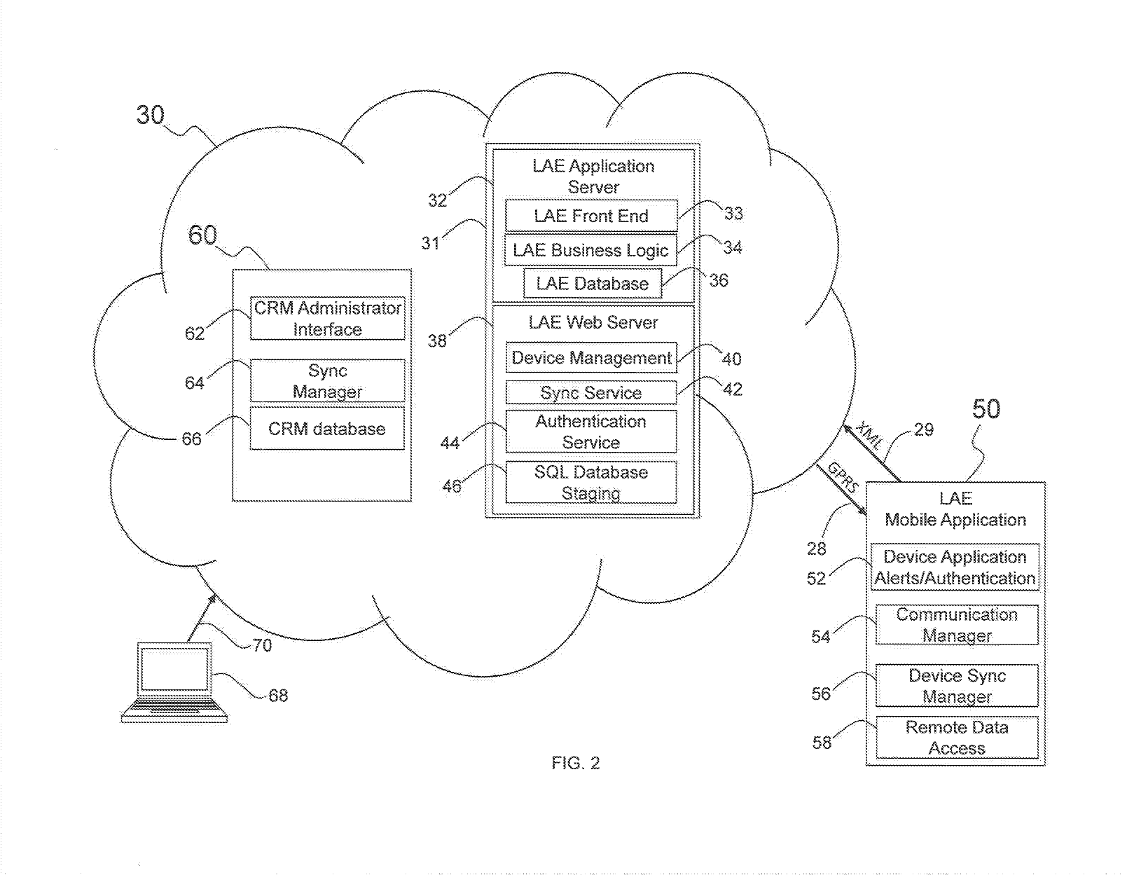

LAE database 36 is structured to contain all data brought into LAE system 31 from CRM system 25 and mobile application 50. The CRM system 25 running on computing platform 10 and the mobile application 50 are two examples of an end-user application. The end-user application can be a mobile-application, a web-based application, a program running on a remote computing device 68 (seen in FIG. 2), or another type of application which provides for the submission of data to the LAE system. The information brought into LAE system 31 may be new information or an update to information already existing in LAE system 31 LAE system 31 is configured to track LAE database 36 and business logic 34 changes.

In some instances, the fields in LAE database 36 do not exactly match the naming convention used in CRM system 25. To overcome this, a map is created that links database 36 fields to CRM database 22 fields. Since LAE system 31 may be used with many, and different, CRM systems, mapping is used to ensure that data fields are properly linked to each other. LAE database 36 has only the data elements from the CRM system 25 that are identified in a data map. The LAE database 36 will house all the data elements identified in the data map. The LAE database is a superset of the CRM program, in that LAE database contains every defined field from CRM database 22 plus additional fields defined by the LAE system 31. While there is commonality between different CRM packages, different naming conventions are used necessitating the use of a map. LAE Database 36 needs to map to these different elements in CRM database 22, but LAE database 36 needs to store non CRM data fields to handle analytics and communicate with LAE mobile application 50.

In some instances, LAE business logic 34 transforms data depending on specific rules and workflow. For example, a business rule implemented during the mapping of fields would map an organizations name in one of three possible formats:
1. Department name is mapped to Organization name;
2. Group name is mapped to Department name; or
3. Department name is mapped directly to an identical field, i.e. Department name.

An end user may submit raw data, which could include scanned documents, notes, audio recordings, drawings, and/or photos. In order to process the raw data into a computable format, also included in LAE business logic 34 is an optical character recognition (OCR) engine for reading and interpreting text from scanned documents and storing it as data in the LAE database 36. Storing scanned documents as text allows for faster and more efficient searching within the LAE system 31 and CRM system 25. Voice to text conversion algorithms may also be included to convert audio files to searchable text, also to be stored in LAE database 36.

LAE system 31 may also include a security module that allows similar database access as defined in CRM system 25. For example, in a preferred embodiment of the present invention, a person designated as an account manager having read and write access to a specific account in CRM system 25 will be automatically granted the same level of permission to the same account in LAE system 31. This permission may be changed within LAE system 31 as needed.

LAE database 36 is the storage location for data associated with LAE system 31. For example, LAE database 36 stores information associated with each client such as account name, organization chart, business model, workflow, and attachments. LAE webserver 38 consists of several modules including device management 40, sync service 42, authentication service 44, and a SQL staging database 46. Application server 32 and web server 38 work in conjunction with each other to communicate with CRM computing platform 10 and the LAE mobile application 50.

SQL staging database 46 is used to interact with an integration service that moves data between CRM system 25 and LAE system 31. Using a message queue system, staging database 46 ensures no transactions are lost during the syncing of data between LAE system 31 and CRM system 25. The field updates and document attachments are staged in staging database 46 and are allowed to be synced with the CRM database 22, maintained only in the LAE database 36, or both. Staging database 46 is used when a user creates, for example, a new workflow, business model update, or defining and mapping a new process or organizational structure. Once completed and saved locally, the new data will save over to the LAE database and then synchronize with CRM database 22. Rules contained within business logic 34 may allow the synchronization of all data or only specific pieces of data depending on the needs of the user or client.

Also connected to Cloud 30 is LAE mobile application 50. LAE mobile application 50 consists of Device application alerts/authentication 52, communication manager 54, device sync manager 56, and remote data access manager 58. Mobile application 50 interfaces with cloud 30 by way of data links 28 and 29. Data link 28 utilizes General Packet Radio Service (GPRS) to move data from Cloud 30 to mobile application 50. Alternatively, data link 28 could use a newer standard, such as LTE, in place of GPRS. Data link 29 utilizes Extensible Markup Language (XML) to move data from mobile application 50 to application server 32 and web server 38 located in cloud 30. It is to be appreciated by someone skilled in the art that other communication protocols may be used without departing from the spirit of the invention. Mobile application 50 may be installed and run on a cellular phone, tablet, or other portable computing platform. It is also to be appreciated by someone skilled in the art that non-portable computing platforms may be used to interface with and manage application server 32 and web server 38

Referring now to FIG, 2, a diagram view of the LAE mobile application communicating with CRM cloud server 60 located in Cloud 30 through application server 32 and web server 38 is shown. Cloud server 60 consists of a CRM administrator interface 62, sync manager 64, and CRM database 66. Cloud server 60 communicates with application server 32 and web server 38 by any means known in the industry. Remote computing device 68 connects to cloud 30 through data link 70 to allow management of cloud server 60, application server 32, and web server 38. The interface between the application server 32, webserver 38, and mobile application 50 is similar to the earlier disclosed embodiment.

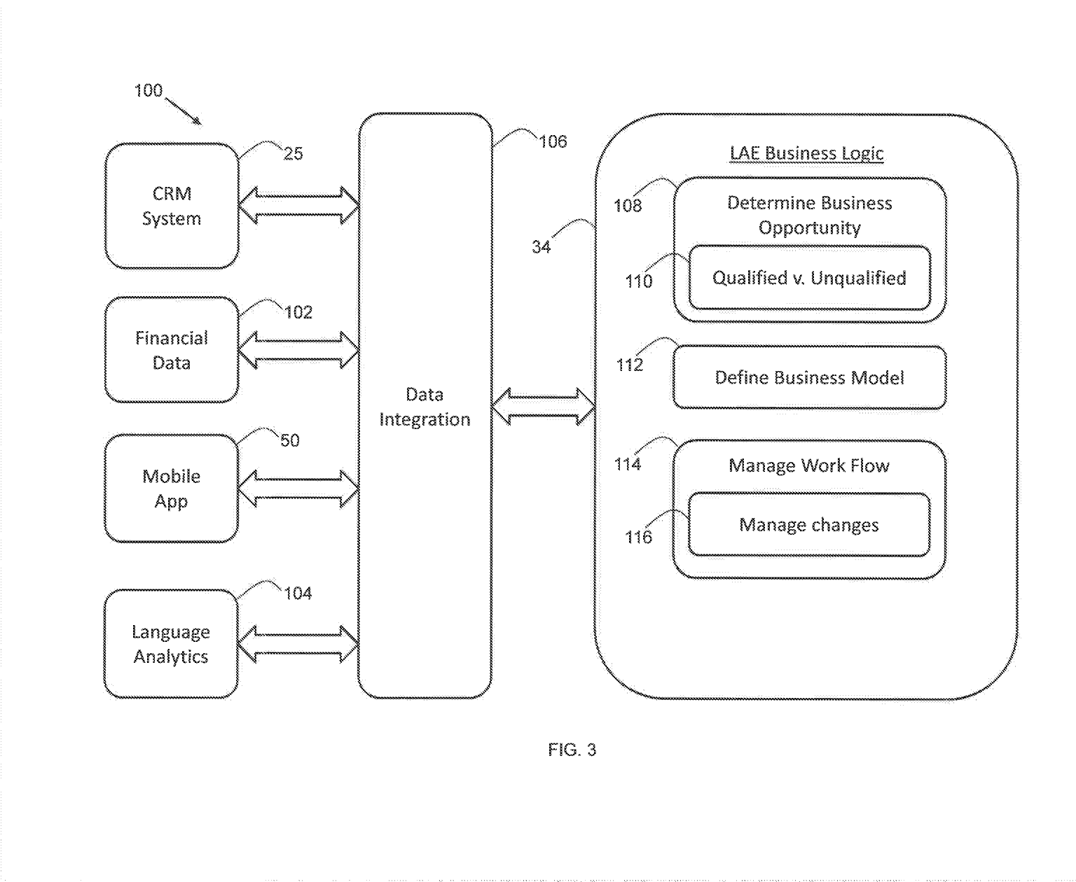

Referring to FIG. 3, a diagram of the function of the business logic 34 portion of the LAE system 31 and generally referred to as 100. Business logic 34 uses multiple data sources to output new pieces of information of value to a user. Data from CRM system 25, a client's financial data 102, data from mobile application 50, and data from language analytics 104 are integrated into LAE system 31. Between optical character recognition, voice-to-text conversion algorithms, and language analytics, raw data is converted into processed data collected into several sources by data integration module 106, finally being prepared for analysis by LAE business logic 34. LAE business logic 34 then analyzes the data to generate possible business opportunities 108. Business logic 34 also uses the data to determine if a business opportunity is qualified or unqualified. The qualification analysis step 110 improves business efficiency by directing resources toward viable opportunities. For example, business logic 34 may receive data from mobile app 50 that a potential business opportunity exists for a client. After receiving the data from mobile app 50, business logic 34 then uses financial data 102 to determine if the client's financial information supports such an opportunity. If it appears that the client's financial position can support the opportunity, business logic 34 will make the opportunity a “qualified” opportunity. If business logic 34 determines the client's financial data does not support such an opportunity, business logic 34 will make the opportunity “unqualified”. It is to be noted that regardless of the determination of “qualified” or “unqualified”, the business opportunity will still be identified by business logic 34. Business logic 34 may also generate a model 112 of a client's business by analyzing data from multiple sources, such as data from CRM system 25, financial data 102, and mobile app 50. Business logic 34 may also create an business organization chart, define the workflow, capture artifacts such as pictures and documents, and create reports. Further, business logic 34 uses all available data to manage work flow 114, which includes managing changes 116 as new data is added to the LAE system 31.

In some embodiments of the present invention, data is encrypted before being transmitted to or from LAE system 31. Financial data 102 is very important to a client and keeping it confidential is typically very important to the client. To achieve this, data may be encrypted before being transmitted either to or from LAE system 31, the communication link(s) itself may be encrypted, or a combination of both encryption techniques used to protect client data.

It is to be appreciated by someone skilled in the art that various features of the preferred embodiments and alternative embodiments may be combined without departing from the scope and spirit of the present invention. While there have been shown what are presently considered to be preferred embodiments of the present invention, it will be apparent to those skilled in the art that various changes and modifications can be made herein without departing from the scope and spirit of the invention.

What is claimed is:

1. A customer relationship management and development system, comprising:
an application server having a front end, a business logic module and a database;
a web server having a device management module, a sync service module an authentication service module, and an SQL staging database;
a plurality of customer profiles each having a fixed number of primary data fields and a plurality of secondary data fields;
a plurality of data links; and
a plurality of end user application comprising:
a means for selecting and retrieving a profile from said plurality of customer profiles;
a means for editing said profile; and
a means for creating a new customer profile and adding it to said plurality of customer profiles,
wherein said plurality of customer profiles is stored in said database of said application server,
wherein said web server is configured to synchronize data between said application server and one or more computing platforms, and
wherein said web server communicates with said plurality of end user applications over said data inks, allowing for the retrieval, editing, and creation of profiles within said plurality of customer profiles.

2. The customer relationship management and development system of claim 1, wherein one or more of said plurality of end user applications is a mobile application.

3. The customer relationship management and development system of claim 2, wherein one or more of said plurality of data links comprises a radio communications system.

4. The customer relationship management and development system of claim 3, wherein data is transferred over said radio communications system in XML format.

5. The customer relationship management and development system of claim 1, further comprising a computing platform having a central processing unit, a memory, a data storage a network interface, and a customer relationship management system, wherein said web server synchronizes data between said application server and said customer relationship management system.

6. The customer relationship management and development system of claim 5, wherein said customer relationship management system has an application programming interface through which said web server communicates with said customer relationship management system.

7. The customer relationship management and development system of claim 5, wherein said customer relationship management system communicates with said web server using HTML.

8. The customer relationship management and development system of claim 1, further comprising:
a plurality of customer financial data;
a plurality of business opportunities;
a plurality of raw data provided through said plurality of end user applications; and
a data integration module configured to transform said plurality of raw data into a plurality of processed data,
wherein said business logic module is configured to retrieve said plurality of customer financial data, said plurality of business opportunities, and said plurality of processed data from said data integration module, and
wherein said business logic module is configured to produce a report of the viability of said plurality of business opportunities based on said plurality of customer financial data and said plurality of processed data.

9. A customer relationship management and development system, comprising:
a cloud platform having an application server, a web server, and a plurality of data links;
a customer relationship management application having a user interface, an administrator interface, an application engine, a database, and a sync manager;
a plurality of customer profiles, each having a fixed number of primary data fields and a plurality of secondary data fields; and
a plurality of end-user applications, comprising:
a means for selecting and retrieving a profile from said plurality of customer profiles;
a means for editing said profile; and
a means for creating a new profile and adding it to said plurality of customer profiles,
wherein said application server has a front end, a business logic module, and a database,
wherein said web server has an authentication module and an SQL staging database,
wherein said plurality of customer profiles is stored in said database of said application server,
wherein said web server is configured to synchronize data between said application server and said customer relationship management application, and
wherein said web server communicates with said plurality of end user applications over said data links, allowing for the retrieval, editing, and creation of profiles within said plurality of customer profiles.

10. The customer relationship management and development system of claim 9 wherein the web server and the customer relationship management application are part of the application server.

11. The customer relationship management and development system of claim 9 wherein the customer relationship management application comprises a server distinct from the web server.

12. The customer relationship management and development system of claim 10 wherein the web server comprises a server distinct from the application server.

13. The customer relationship management and development system of claim 9 further comprising one or more internet-connected customer relationship management servers wherein the customer relationship management application runs on said one or more internet-connected customer relationship management servers.

14. The customer relationship management and development system of claim 9 wherein at least one of said plurality of end-user applications is a program running on a remote computing device.

15. The customer relationship management and development system of claim 14 wherein said program is a mobile application, and wherein said remote computing device is a mobile platform.

16. The customer relationship management and development system of claim 9 wherein at least one of said plurality of end-user applications is a web application.

17. The customer relationship management and development system of claim 9 further comprising a plurality of raw data provided through one or more of said plurality of end user applications,
wherein said cloud platform further comprises one or more algorithms configured to transform said plurality of raw data into a plurality of computable data,
wherein said cloud platform is configured to analyze said plurality of computable data and generate an output therefrom, and
wherein said one or more of said plurality of end user applications is configured to retrieve said output and transform said output into a human-perceivable signal.

18. A method for the collection and documentation of complex customer requirements, the method comprising:
providing an application server having an application server database and a business logic application;
providing a web server having an SQL staging database;
providing a customer relationship management system with customer account information;
providing customer financial data;
providing an end-user application;
entering raw data into said end-user application;
transferring said customer account information from said customer relationship management system to said web server;
transferring said customer financial data to said web server;
transferring said raw data to said web server;
converting said raw data into processed data using optical character recognition and a voice-to-text algorithm;
integrating said customer account information, said customer financial data, said raw data, and said processed data into integrated data in said SQL staging database;
transferring said integrated data to said application server database;
analyzing said integrated data with said business logic application to determine if a business opportunity exists;
qualifying said business opportunity with said business logic application using said integrated data;
defining a customer business model with said business logic application;
managing work flow with said business logic application using said integrated data;
acquiring new customer account data from the customer relationship management system;
acquiring new customer financial data;
entering new raw data into the end-user application;
updating said integrated data into updated integrated data with said new customer account data, said new customer financial data, and said new raw data; and
managing work flow changes with said business logic application using said updated integrated data.

19. The method for the collection and documentation of complex customer requirements of claim 18, wherein the end-user application is a mobile application.

20. The method for the collection and documentation of complex customer requirements of claim 18, further comprising:
analyzing said processed data with language analytics to create an analyzed data set; and
determining customer preferences from said analyzed data set with said business logic application.
